(19) United States
(12) Patent Application Publication
(10) Pub. No.: US 2004/0001713 A1
(43) Pub. Date: Jan. 1, 2004

(54) Wavelength division multiplexer

(75) Inventors: Alan Ting, Hsinchu (TW); Phoeby Lin, Hsinchu (TW); Ted Huang, Hsinchu (TW)

Correspondence Address: BACON & THOMAS, PLLC, 625 SLATERS LANE, FOURTH FLOOR, ALEXANDRIA, VA, 22314

(73) Assignee: RiTek Corporation, Hsinchu (TW)

(21) Appl. No.: 10/445,953

(22) Filed: May 28, 2003

(30) Foreign Application Priority Data
May 29, 2002 (TW) 91207862

(51) Int. Cl. H04J 14/02

(52) U.S. Cl. 398/48

(57) ABSTRACT

A wavelength division multiplexer is disclosed. A first holding unit and a second holding unit are used to securely attach a first pig-tail unit of a first collimator to a first gradient index lens. Also, a third holding unit and a fourth holding unit are used to securely attach a second pigtail unit of a second collimator to a second gradient index lens. A filter is attached between the first collimator and the second collimator in an adhesive manner. A fifth holding unit sandwiches the second and the fourth holding units to securely attach the first collimator to the second collimator.

### BACKGROUND OF THE INVENTION

1. Field of the Invention

The present invention relates to a passive optical component, and more particularly, to a packaged attachment device of wavelength division multiplexer (WDM).

2. Description of Related Art

Increases in capacity of an optical fiber network have recently been in strongly demand. The wavelength division multiplexing technology has been used widely and one example thereof is an eight (dense) channel wavelength division multiplexer (DWDM). The wavelength division multiplexer is used to filter signals having different wavelengths irradiating from an optical signal source, FIG. 1 is a schematic view of a prior packaged attachment of wavelength division multiplexer (WDM). As shown in FIG. 1, a WDM is comprised of two collimators 100, 200 and a filter unit 300. When the two collimators are attached and fixed together, a first gradient index (GRIN) lens 120 of the first collimator 100 is attached to the filter unit 300 and a second gradient index lens 220 of the second collimator 200, and a heat curing epoxy 420 is applied to the joints between the first gradient index lens 120 and the filter unit 300 and between the filter unit 300 and the second gradient index lens 220; and then, a first pigtail unit 110 of the first collimator 100 is glued to the first gradient index lens 120 with a heat curing epoxy 410 after optical alignment process; and finally, a second pig tail unit 210 of the second collimator 200 being optically aligned is glued to the second gradient index lens 220 with a heat curing epoxy 430.

The aforesaid WDM uses the epoxies 410, 420, 430 to glue the respective optical elements. Hence, the epoxies 410, 420, 430 are disposed on the optical path of an optical signal transmission. In a high power optical signal transmission system, because joints existing where the first pig tail unit 110 is glued to the first gradient index lens 120 with the heat curing epoxy 410 and where the second pig tail unit 210 is glued to the second gradient index lens 220 with the heat curing epoxy 430 are subject to a high temperature as a result of high optical power intensity, the epoxies are susceptible to diffuse onto or spread over the optical path of the collimators 100, 200. The optical signal transmission will therefore be effected. Although an attempt has been made to apply the epoxies 410, 420, 430 to a position other than the joints to prevent the optical path from any contamination, it is found to be difficult in practice. Another attempt has been proposed to seal the joints between the optical elements by applying an ultraviolet (UV) adhesive, and then the heat curing epoxy is applied for bonding together. The adhesive intensity of such a proposed alternative may be weak, however.

Therefore, it is desirable to provide a wavelength division multiplexer to mitigate and/or obviate the aforementioned problems.

### SUMMARY OF THE INVENTION

It is an object of the present invention to provide a packaged arrangement for wavelength division multiplexer so as to securely attach the wavelength division multiplexer by applying a heat curing epoxy directly to areas away from the optical path of the respective optical elements of the wavelength division-multiplexed.

It is another object of the present invention to provide a wavelength division multiplexer (WDM) so as to scale down the size of the WDM.

It is a fiber object of the present invention to provide a wavelength division multiplexer (WDM) so as to facilitate optical alignment of optical elements, simplify processing steps, and reduce manufacturing cost.

To attain the above objects, the wavelength division multiplexer of the present invention includes: a first holding unit; a second holding unit; a first collimator having a first pigtail unit and a first gradient index (GRIN) lens wherein said first holding unit sandwiches the two sides of said first pigtail unit, said second holding unit sandwiches the two sides of said first gradient index lens, and said first holding unit is adhered to said second holding unit by applying an ultraviolet (UV adhesive or a heat curing adhesive to secure said first pigtail unit and said first gradient index lens together; a third holding unit; a fourth holding unit; a fifth holding unit; a filter unit; and a second collimator having a second pigtail unit and a second gradient index lens wherein said third holding unit sandwiches the two sides of said second pigtail unit, said fourth holding unit sandwiches the two sides of said second gradient index lens, and said third holding unit is adhered to said fourth holding unit by applying an ultraviolet (UV) adhesive or a heat curing adhesive to secure said second pigtail unit and said second gradient index lens together; wherein said filter unit is sandwiched between said first collimator and said second collimator, and both said first collimator and said second collimator are attached and secured by said fifth holding unit.

Other objects, advantages and novel features of the invention will become more apparent from the following detailed description when taken in conjunction with the accompanying drawings.

### BRIEF DESCRIPTION OF THE DRAWINGS

FIG. 1 is a schematic view of a prior WDM; and

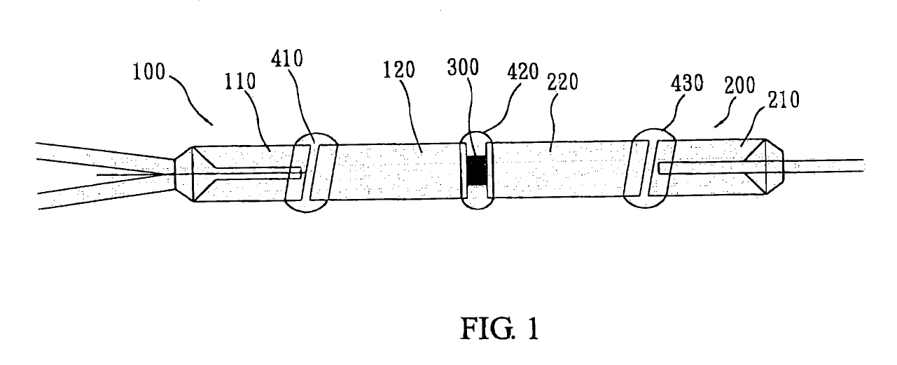

FIG. 2 is a schematic view of a WDM according to the present invention.

### DETAILED DESCRIPTION OF THE PREFERRED EMBODIMENT

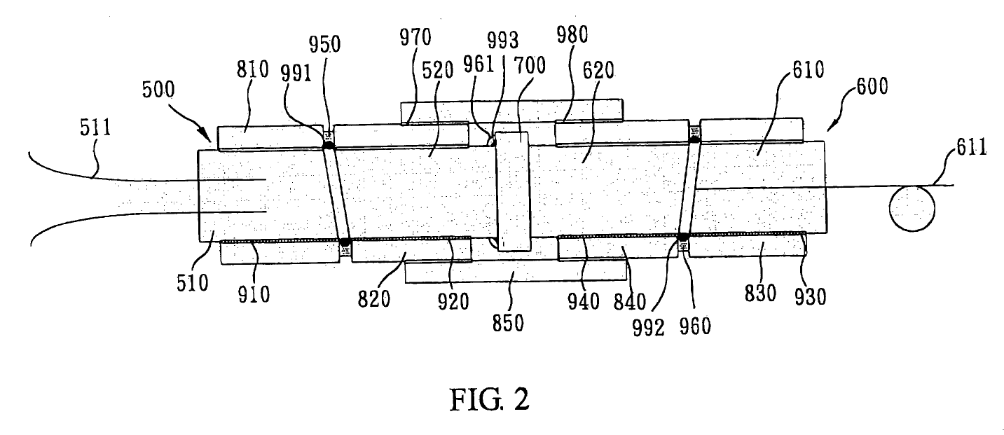

Refer to FIG. 2, for a preferred embodiment of the present invention, illustrating a schematic view of a wavelength division multiplexed according to the present invention. The WDM- of the present invention comprises a first collimator 500, a second collimator 600, a filter unit 700, a first holding unit 810, a second holding unit 820, and holding unit 830, a fourth holding unit 840, and a fifth holding unit 850; wherein the first collimator 500 includes a first pigtail unit 510 and a first gradient: index lens 520, and the second collimator 600 includes a second pigtail unit 610 and a second gradient index lens 620.

The aforesaid holding units 810, 820, 830, 840, 850 can be shaped as any conventional one, and preferably; is cylindrically-shaped (or sleeve, tube) in the present invention. The material of the holding units is preferably metal, and more preferably, stainless steel. Hence the manufacturing process is simple, the manufacturing cost is low, and the size of the whole set WDM is minimal.

The first pigtail unit 510 of the present embodiment is preferably a dual fiber pigtail unit having two transmitting optical fibers 511. The second pigtail unit 610 of the present embodiment is preferably a single fiber pigtail unit having only one transmitting optical fiber 611. When an optical signal having multiple wavelengths is input through the dual fiber pigtail unit, only an optical signal having a predetermined wavelength can be output through the single fiber pigtail unit while the optical signal having the other wavelengths is output through the other optical fiber of the dual fiber pigtail unit to a piece of equipment or a component to be attached or alternatively a next WDM.

Attachment of the first collimator 500 is as follows. The first holding unit 810 sandwiches the first pigtail unit 510, being adhered to the outside boundary portions of the first pigtail unit 510 with a heat curing adhesive 910. In this embodiment, the heat curing adhesives 910, 920, 930, 940, 950, 960, 961, 970, 980 are preferably the 353ND heat-curing adhesive. The second holding unit 820 sandwiches the first gradient index lens 520, being adhered to the outside boundary portions of the first gradient index lens 520 with the heat curing adhesive 920. The first holding unit 810 and the second holding unit 820 are bound together with an UV adhesive 991 to seal the joint between the first pigtail unit 510 of the firsts collimator and the first gradient index lens 520, and then, the heat curing adhesive 950 is applied to strengthen the attachment of the first pigtail unit 510 to the first gradient index lens 520.

Attachment of the second collimator 600 is similar to that of the first collimator 500. The third holding unit 830 sandwiches the second pigtail unit 610, being adhered to the outside boundary portions of the second pigtail unit 610 with the heat curing adhesive 930. The fourth holding unit 840 sandwiches the second gradient index lens 620, being adhered to the outside boundary portions of the second gradient index lens 620 with the heat curing adhesive 940. The third holding unit 830 and the fourth holding unit 840 are bound together with a UV adhesive 992 to seal the joint between the second pigtail unit 610 of the second collimator and the second gradient index lens 620, and then, the heat curing adhesive 960 is applied to strengthen the attachment of the second pigtail unit 610 to the second gradient index lens 620.

The filter unit 700 is adhered to the first collimator 500 wherein the joint between the filter unit 700 and the first gradient index lens 520 is sealed by a UV adhesive 993, and then, the heat curing adhesive 961 is applied for secure bonding. An optical signal having a predetermined wavelength λ₁ is allowed to pass through the filter unit 700 of the present embodiment while optical signals having a wavelength other than the predetermined wavelengthλ₁ is reflected.

Finally, the first collimator 500 is securely attached to the second collimator 600 by means of the fifth holding unit 850. The fifth holding unit 850 sandwiches or fits on the second holding unit, 820 and the fourth holding unit 840. Also, the heat curing adhesives 970, 980 are applied to attach the fifth holding unit 850 to the second holding unit 820 and the fourth holding unit 840, respectively. It is sure that the heat curing adhesives 910, 920, 930, 940, 950, 960, 961, 970, 980 can be replaced with a heat curing epoxy to bind the optical elements and the holding units together.

As described above, the present invention uses a stainless steel tube to securely attach the pigtail unit to the gradient index lens and the two collimators. Furthermore, the heat curing epoxy, the UV adhesive or the heat curing adhesive is used to bind the optical elements and the tube of stainless steel so as to securely attach the optical elements and prevent the optical path of an optical signal transmission from being contaminated as a result of the use of the heat curing epoxy or the heat curing adhesive. Moreover, the use of the stainless steel tube having a thin thickness facilitates mass production. Consequently, the size and manufacturing cost of the wavelength division multiplexer are greatly reduced, as compared with the prior glass tube having a less-thinner thickness.

Although the present invention has been explained in relation to its preferred embodiment, it is to be understood that many other possible modifications and variations can be made without departing from the spirit and scope of the invention as hereinafter claimed.

What is claimed is:

1. A wavelength division multiplexer, comprising:
a first holding unit;
a second holding unit;
a first collimator having a first pigtail unit and a first gradient index (GRIN) lens wherein said first holding unit sandwiches the two sides of said first pigtail unit, said second holding unit sandwiches the two sides of said first gradient index lens, and said first holding unit is adhered to said second holding unit by applying an ultraviolet (UV) adhesive or a heat curing adhesive to secure said first pig-tail unit and said first gradient index lens together;
a third holding unit:
a fourth holding unit;
a fifth holding unit;
a filter unit; and
a second collimator having a second pig tail unit and a second gradient index lens wherein said third holding unit sandwiches the two sides of said second pigtail unit, said fourth holding unit sandwiches the two sides of said second gradient index lens, and said third holding unit is adhered to said fourth holding unit by applying an ultraviolet (UV) adhesive or a heat curing adhesive to secure said second pig tail unit and said second gradient index lens together; wherein said filter unit is sandwiched between said first collimator and said second collimator, and both said first collimator and said second collimator are attached and secured by said fifth holding unit.

2. The wavelength division multiplexer of claim 1, wherein said fifth holding unit sandwiches said second holding unit and said forth holding unit.

3. The wavelength division multiplexer coupler of claim 1, wherein said heat curing adhesive is a heat curing epoxy.

4. The wavelength division multiplexer of claim 1, wherein said first holding unit, said second holding unit, said third holding unit, said forth holding unit or said fifth holding unit is made of metal.

5. The wavelength division multiplexer of claim 1, wherein said first holding unit, said second holding unit, said third holding unit, said forth holding unit or said fifth holding unit is made of stainless steel.

6. The wavelength division multiplexer of claim 1, wherein said first, second, third or forth holding unit sandwiches said first and said second collimators by applying said heat curing adhesive or said ultraviolet (UV) adhesive.

7. The wavelength division multiplexer of claim 1, wherein said fifth holding unit sandwiches said second holding unit and said forth holding unit by applying said heat curing adhesive or said ultraviolet (UV) adhesive.

8. The wavelength division multiplexer of claim 1, wherein said filter unit is attached to said first collimator by applying said heat curing adhesive or said ultraviolet (UV) adhesive.

9. The wavelength division multiplexer of claim 1, wherein said first pigtail unit is a dual fiber pigtail unit and said second pigtail unit is a single fiber pigtail unit.

10. The wavelength division multiplexer of claim 1, wherein said first holding unit said second holding unit, said third holding unit or said
forth holding unit is a sleeve or a tube.
